(19) United States
(12) Patent Application Publication
(10) Pub. No.: US 2007/0047517 A1
(43) Pub. Date: Mar. 1, 2007

(54) Method and apparatus for altering a media activity

(76) Inventors: Hua Xu, Lake Zurich, IL (US); John M. Harris, Chicago, IL (US)

Correspondence Address: MOTOROLA, INC., 1303 EAST ALGONQUIN ROAD, IL01/3RD, SCHAUMBURG, IL, 60196, US

(21) Appl. No.: 11/214,259

(22) Filed: Aug. 29, 2005

(51) Int. Cl. H04L 12/66

(52) U.S. Cl. 370/352

(57) ABSTRACT

A method and apparatus for altering a media activity are disclosed. The provision (101) of a dynamic media activity to a recipient user is enhanced by the dynamic acquisition (102) of information regarding an ambient condition of the user's environment and the use (104) of the information to dynamically alter the media activity in a manner that correlates with the information. An apparatus (200) embodying the method comprises a dynamic media activity engine (201) operably linked to a memory (202) having information regarding at least one ambient condition of the user and to a user interface (205). Information regarding ambient conditions may be obtained by an ambient condition detector (203) linked to the memory (202) or by means of a wireless interface (204).

### TECHNICAL FIELD

This invention relates generally to dynamic media activities.

### BACKGROUND

The provision of dynamic media activities to recipient users is well known in the art. Common examples of dynamic media activities are audio-visual programs and interactive computer games. Audio-visual programs may be generally characterized as passive experiences for the user, wherein the user does little more than select what audio-visual program or part of a program to experience. Interactive computer games may be generally characterized as potentially active or interactive experiences for the user wherein input from the user can be used to cause selective alterations of the media activity provided.

It is often desirable to provide realism (or at least an increased perception of reality) in dynamic media activities. Some prior art methods attempt to enhance realism by, for example, drawing the recipient user into the environment of the media activity. This has been done by extending the dynamic media activity into the user's environment using techniques such as surround sound or wrap-around video displays.

Such prior art methods, though successful at least in some measure in some instances, do not fully address the potential needs of all potential users. In some cases, for example, the real world circumstances being experienced by a user who is also partaking in a given dynamic media activity can be sufficiently intense and/or otherwise distracting to the point of essentially defeating the cognitive value of so attempting to extend the dynamic media activity into the user's environment. This occurs, for example, when a local environmental experience is highly contrary to a virtual experience being suggested via the dynamic media activity.

### BRIEF DESCRIPTION OF THE DRAWINGS

The above needs are at least partially met through provision of the method and apparatus for altering a media activity described in the following detailed description, particularly when studied in conjunction with the drawings, wherein:

FIG. 1 comprises a flow chart of a method in accordance with various embodiments of the invention; and

FIG. 2 comprises a block diagram of an apparatus as configured in accordance with various embodiments of the invention.

Skilled artisans will appreciate that elements in the figures are illustrated for simplicity and clarity and have not necessarily been drawn to scale. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one alters (by, for example, enhancing) the realism of a dynamic media activity by acquiring information regarding ambient conditions experienced by a recipient user of the dynamic media activity and using that information to alter the media activity. In a preferred embodiment these events occur substantially in a real-time manner. The ambient conditions can comprise any condition of choice with examples comprising visual conditions, auditory conditions, temperature conditions, haptic conditions, and so forth. The alterations of the dynamic media activity can, in turn, correspond (at least in a preferred approach) to the nature of the ambient condition (or conditions) in question. In one approach, the dynamic media activity can be altered in such a manner that an ambient condition of the user is mirrored in the media activity, thereby extending the user's environment into the environment of the media activity. This could be done, for example, by branching an audio-visual program being presented to a segment wherein the weather conditions in the audio-visual program are similar to those at the user's location. Those skilled in the art will recognize a wide variety of ways in which a dynamic media activity can be altered so as to mirror one or more ambient conditions of a recipient user.

In another approach, information about one or more ambient conditions of a user may be used to alter a dynamic media activity in a manner that, rather than mirroring the information, correlates with it in a more indirect manner. For example, if the information indicates that a user is driving down a particularly bumpy road, a character in a video game being played by the user might bounce down a staircase. As another example, if the information indicates a sudden forward acceleration of the vehicle in which a user is riding, a character in a video game being played by the user might be shoved from behind.

So configured, environmental conditions (including even relatively intense and/or otherwise highly obtrusive conditions), instead of potentially distracting the user, can themselves serve to highlight, supplement, and/or otherwise at least potentially enhance the user's perception and interaction with the dynamic media activity. These and other benefits may become clearer upon making a thorough review and study of the following detailed description.

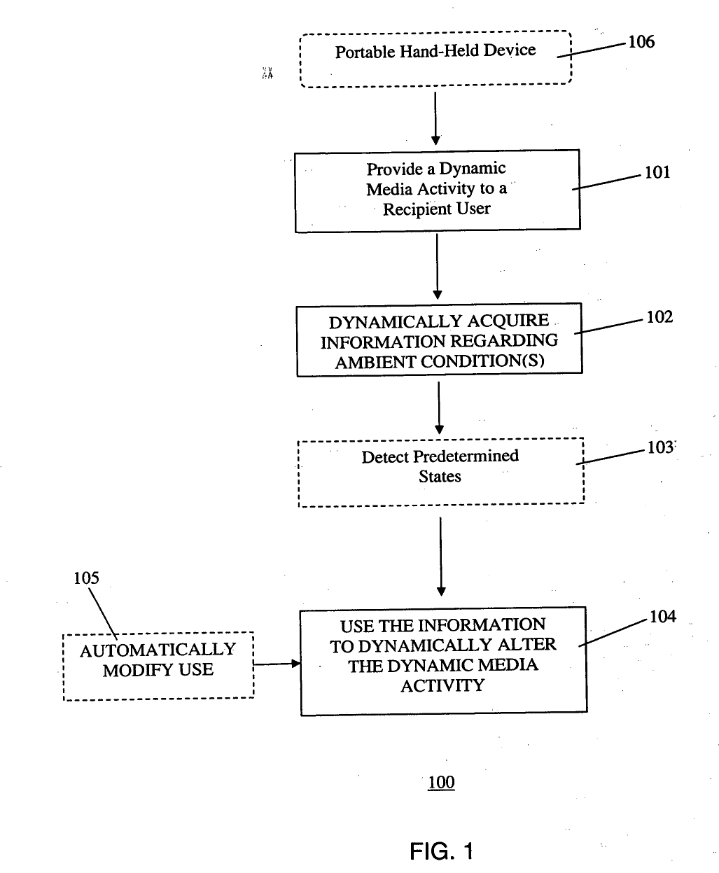

Referring now to the drawings, and in particular to FIG. 1, an exemplary process 100 that accords with these teachings provides 101 a dynamic media activity to a recipient user. Common examples of dynamic media activities include audio-visual programs, audio narrations, musical programs, virtual reality simulations, and interactive electronic games to name but a few. In a preferred embodiment, the dynamic media activity is provided via a portable hand-held apparatus 106, but it will be recognized by those skilled in the art that the dynamic media activity can be provided by any apparatus adapted for that purpose. Such dynamic media activities and their implementing platforms are well known in the art and others will no doubt be introduced in the future. For this reason, and further because these teachings are not overly sensitive to selection or use of any particular dynamic media activity and/or a corresponding implementing platform, further elaboration regarding such elements will not be provided here for the sake of brevity.

The process 100 further provides for the dynamic acquisition 102 of information regarding at least one ambient condition for the recipient user (i.e., an ambient condition that is being experienced by, or will likely be experienced by, the recipient user). By way of example and not by way of limitation, the information may comprise data concerning a present geographic location of the user, present weather conditions at the location of the user, present ambient illumination conditions, ambient temperature, ambient sounds, ambient odors, present acceleration, present geographic trajectory, and/or a present haptic condition. In a preferred embodiment, the information is acquired 102 by the portable hand-held apparatus 106. By way of examples, information may be acquired 102 using sensors built in to or in communication with the hand-held apparatus 106 or which may be communicated to the hand-held apparatus 106 via, for example, wireless messaging from a remote source (using, for example, radio frequency, optical, or sonic bearer channels as are known in the art).

This process 100 uses the acquired information to dynamically alter 104 the dynamic media activity. In a preferred embodiment, the media activity is altered by providing media content that correlates, at least in part, to the acquired information. The following examples of how information might be used 104 may help the reader to understand the spirit of the process 100. As a first example, when the information indicates that a vehicle in which the recipient user is riding is making a right hand turn, that may be reflected by altering the media activity to have the user encounter a right hand turn in a corresponding video game. Further examples include: when the user is in a vehicle that enters a tunnel, information about ambient illumination conditions can be used to alter a video game storyline to direct the presentation of a scenario wherein a character in the video game encounters a dark environment; detection of thunder sounds in the user's environment may be used to trigger the appearance of lightning in a video game; if the user is in a vehicle encountering a series of speed bumps, the character in a video game may encounter a series of explosions; ambient sounds such as car horns honking or birds chirping may trigger similar sounds within a video game; and information about present weather conditions of the user may be used to branch an audio-visual program being provided to the user to a story portion or storyline that reflects and/or otherwise incorporates those weather conditions. Yet further examples of the use of information about present weather conditions include: the presence of snowfall in the user's environment may be reflected in a video game as a blinding visualization due to snow reflecting sunlight in the game or as a reduced visibility due to airborne snow in the game; and information about extreme hot or cold conditions may be used to alter the power level or general effectiveness of characters in the game.

In some situations it may be desirable to optionally automatically modify 105 the manner in which the information is used. For example, ambient conditions being experienced by the user may not be appropriate for the video game being played. Also in one embodiment of the invention, then, the detection 103 of a predetermined state is used to trigger a modification 105 in the manner in which information is used 104 to dynamically alter the media activity. For example, the user might preselect a level of intensity for the correlation between the information and the media content that is provided to the user. As another example, if the information indicates that the user is in a any number of given environments, the intensity with which information is used to alter 104 the media activity could be automatically dialed down or may reach a threshold. As a further example, when the intensity of an ambient condition surpasses a predetermined threshold, the linkage between the information about the user and the video game could be completely disengaged and the user may be provided with a notification of that change.

Those skilled in the art will appreciate that the above-described processes are readily enabled using any of a wide variety of available and/or readily configured platforms, including partially or wholly programmable platforms as are known in the art or dedicated purpose platforms as may be desired for some applications.

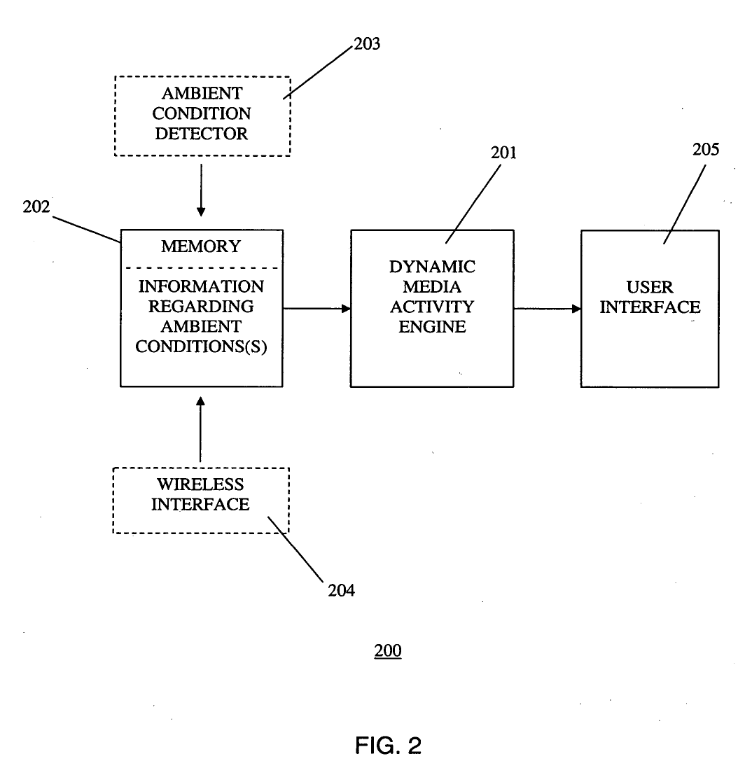

To illustrate, and referring now to FIG. 2, this process 100 may be embodied in an apparatus 200 that comprises a dynamic media activity engine 201. Common examples of dynamic media activity engines include interactive electronic games, audio-visual display units and audio reproduction devices. Those skilled in the art will recognize a wide variety of usable dynamic media activity engines.

The apparatus may further preferably comprise a memory 202 having information regarding at least one ambient condition that is at least potentially perceivable by a recipient user of the dynamic media activity engine 201. The memory 202 could be implemented in any form of machine readable memory and may further be comprised of one or of several constituent storage elements (with such component and architectural options being well understood by those skilled in the art). The dynamic media activity engine 201 is operably coupled to the memory 202 and is configured and arranged (via, for example, appropriate corresponding programming) to use the information to dynamically alter the media activity as provided to the recipient user in a manner consistent with the process 100.

The apparatus further comprises a user interface 205 operably coupled to the dynamic media activity engine 201 for communicating the dynamic media activity to a user. Common examples of user interfaces comprise one or more of a video display device, a sound production device, a scent production device, a rumble production device, and/or a force feedback interface device. Those skilled in the art will recognize a variety of other user interfaces that are potentially usable in accordance with these teachings.

In a preferred embodiment, at least one ambient condition detector 203 (and possibly many such detectors) is operably coupled to the memory 202 for acquiring and storing information regarding at least one ambient condition of the user. The nature of the detector 203, of course, will vary in accordance with the particular ambient condition of interest. Alternatively, or in addition, a wireless interface 204 may be configured and arranged to receive information concerning at least one ambient condition of the user and be operably coupled to the memory 202 for storing the information. To illustrate, such a wireless interface 204 may take the form of a device for receiving wireless messages via a cellular network.

Those skilled in the art will recognize and understand that such an apparatus 200 may be comprised of a plurality of physically distinct elements as is suggested by the illustration shown in FIG. 2. It is also possible, however, to view this illustration as comprising a logical depiction, in which case one or more of these elements can be enabled and realized via a shared platform. It will also be understood that such a shared platform may comprise a wholly or at least partially programmable platform as are known in the art.

So configured, such an apparatus, programmed and/or otherwise arranged to comport with these teachings, can facilitate the alteration of any of a variety of dynamic media activities such that environmental stimuli and/or otherwise perceivable external conditions can supplement and enhance the user's experience with respect to the dynamic media activity. The specific environmental condition to which the activity responds, and the precise nature of that response, can vary widely to reflect the needs and/or capabilities of the apparatus itself as will be understood by those skilled in the art.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
providing a dynamic media activity to a recipient user;
dynamically acquiring information regarding at least one ambient condition, which at least one ambient condition is at least potentially perceivable by the recipient user during the dynamic media activity;
using the information to dynamically alter the dynamic media activity as is provided to the recipient user.

2. The method of claim 1 wherein providing a dynamic media activity comprises providing at least one of:
an interactive multimedia game activity;
a multimedia story;
an oral narration.

3. The method of claim 1 wherein providing a dynamic media activity comprises providing the dynamic media activity via a portable hand-held apparatus.

4. The method of claim 3 wherein dynamically acquiring information regarding at least one ambient condition comprises dynamically acquiring information using the portable hand-held apparatus.

5. The method of claim 4 wherein dynamically acquiring information using the portable hand-held apparatus comprises dynamically acquiring at least a portion of the information from a remote source via the portable hand-held apparatus.

6. The method of claim 1 wherein dynamically acquiring information regarding at least one ambient condition comprises dynamically acquiring information regarding at least one of:
a present geographic location;
a present geographic trajectory;
present acceleration;
present weather conditions;
present illumination conditions;
temperature;
ambient sound;
a present odor;
a present haptic condition.

7. The method of claim 1 wherein using the information to dynamically alter the dynamic media activity as is provided to the recipient user comprises dynamically altering the dynamic media activity with respect to at least one of:
an audible component of the dynamic media activity;
a visual component of the dynamic media activity;
a haptic component of the dynamic media activity;
an olfactory component of the dynamic media activity.

8. The method of claim 1 wherein using the information to dynamically alter the dynamic media activity as is provided to the recipient user comprises dynamically altering the dynamic media activity to automatically cause provision of media content that correlates, at least in part, to the information.

9. The method of claim 1 wherein using the information to dynamically alter the dynamic media activity as is provided to the recipient user further comprises anticipating changes to at least one ambient condition to dynamically alter the dynamic media activity to automatically cause provision of media content that correlates, at least in part, to the anticipated changes to the at least one ambient condition.

10. The method of claim 1 further comprising:
detecting at least a first predetermined state;
automatically modifying use of the information to dynamically alter the dynamic media activity as is provided to the recipient user in response to detecting the predetermined state.

11. An apparatus comprising:
a memory having information regarding at least one local ambient condition stored therein, which at least one ambient condition is at least potentially perceivable by an apparatus user;
a dynamic media activity engine configured and arranged to use the information to dynamically alter a dynamic media activity as is provided to the apparatus user; and
a user interface operably coupled to the dynamic media activity engine.

12. The apparatus of claim 10 further comprising an ambient condition detector operably coupled to the memory and configured to provide information regarding at least one local ambient condition.

13. The apparatus of claim 10 further comprising:
a wireless interface configured and arranged to receive the information and being operably coupled to the memory such that the information, upon being received, is automatically stored in the memory.

14. The apparatus of claim 10 wherein the user interface comprises at least one of:
a video display device;
a sound production device;
a scent production device;
a rumble production device;
a force feedback interface device.

15. The apparatus of claim 10 wherein the dynamic media activity engine comprises means for dynamically altering the dynamic media activity to automatically cause provision of media content that correlates, at least in part, to the information.

16. An apparatus comprising:
memory means for storing information regarding at least one local ambient condition, which at least one ambient condition is at least potentially perceivable by an apparatus user;
dynamic media activity provision means for presenting a dynamic media activity to the apparatus user; and
a user interface operably coupled to the dynamic media activity provision means.

17. The apparatus of claim 15 wherein the dynamic media activity provision means comprises means for dynamically altering the dynamic media activity to automatically cause provision of media content that correlates, at least in part, to the information.
